(19) United States
(12) Patent Application Publication
(10) Pub. No.: US 2019/0049830 A1
(43) Pub. Date: Feb. 14, 2019

(54) LIGHT SOURCE DEVICE AND ELECTRONIC APPARATUS

(71) Applicant: SONY CORPORATION, TOKYO (JP)

(72) Inventors: SHINICHIRO TAJIRI, KANAGAWA (JP); MASAHIRO ISHIGE, KANAGAWA (JP)

(21) Appl. No.: 16/080,161

(22) PCT Filed: Jan. 19, 2017
(86) PCT No.: PCT/JP2017/001747

§ 371 Date: Aug. 27, 2018

(30) Foreign Application Priority Data
Mar. 7, 2016 (JP) 2016-043606

(51) Int. Cl. G03B 21/20; F21V 14/08; F21V 9/40; F21V 5/04; F21V 9/35

(52) U.S. Cl. CPC G03B 21/204; F21V 14/08; F21V 9/35; F21V 5/043; F21V 9/40

(57) ABSTRACT

This light source device includes: a wavelength conversion element that absorbs a portion of an incident first color beam and outputs a second color beam in a wavelength region that is different from a wavelength region of the first color beam, and outputs an unabsorbed portion of the first color beam; a first optical system that outputs the first color beam toward the wavelength conversion element, while concentrating the first color beam, and sets a focal position of the first color beam to a position shifted from a position on the wavelength conversion element; and a second optical system that is disposed on light output side of the wavelength conversion element, and includes an optical member that concentrates light on a different position depending on a wavelength.

### TECHNICAL FIELD

The disclosure relates to a light source device and an electronic apparatus that use a wavelength conversion element.

### BACKGROUND ART

In recent years, a light source device that emits light from an excitation light source to a wavelength conversion element and converts a wavelength to output the light of the converted wavelength has been used in an electronic apparatus such as a projector (a projection display unit). To reduce the size of this light source device, there is a technique of using a portion of emitted excitation light transmitted through the wavelength conversion element as it is.

Configurations of the wavelength conversion element used in the light source device as described above fall into, for example, three types: a reflection type, a transmission and reflection type, and a transmission type. Examples of the reflection type wavelength conversion element, among these, include those using a so-called reflection type wheel that reflects both a portion of incident excitation light and light (fluorescence) after wavelength conversion to return them to incident side (for example, PTL 1).

### CITATION LIST

### Patent Literature

PTL 1: Japanese Unexamined Patent Application Publication No. 2012-123179

### SUMMARY OF THE INVENTION

In a configuration of PTL 1 described above, a phase difference element is disposed on the incident side of a wavelength conversion element. In this configuration, turbulence of a polarization plane occurs when excitation light passes through the wavelength conversion element. As a result, in a dichroic mirror in a subsequent stage, efficiency is lowered at the time of dividing light into excitation light incident on the wavelength conversion element and light incident on an illumination system, thus causing an increase in loss of blue light.

Meanwhile, in a light source device using a wavelength conversion element, it is desirable that excitation light be concentrated not on the wavelength conversion element but on a position shifted from a position on the wavelength conversion element. One reason for this is that, in a case where excitation light is concentrated on the wavelength conversion element, the light density in the wavelength conversion element becomes too high, which may result in the reduction in conversion efficiency as well as the damage on a phosphor. However, when a position on which excitation light is concentrated is shifted, it is difficult for an optical system disposed on output side of the wavelength conversion element to adjust respective focal positions of excitation light and fluorescence, thus reducing use efficiency of excitation light. It is desired to suppress the reduction in light use efficiency while achieving the reduction in size.

It is desirable to provide a light source device that makes it possible to suppress reduction in light use efficiency while achieving reduction in size and an electronic apparatus using such a light source device.

A first light source device in an embodiment of the disclosure includes: a wavelength conversion element that absorbs a portion of an incident first color beam and outputs a second color beam in a wavelength region that is different from a wavelength region of the first color beam, and outputs an unabsorbed portion of the first color beam; a first optical system that outputs the first color beam toward the wavelength conversion element, while concentrating the first color beam, and sets a focal position of the first color beam to a position shifted from a position on the wavelength conversion element; and a second optical system that is disposed on light output side of the wavelength conversion element, and includes an optical member that concentrates light on a different position depending on a wavelength.

A first electronic apparatus of an embodiment of the disclosure includes the first light source device of the foregoing embodiment of the disclosure.

In the first light source device and electronic apparatus of the embodiment of the disclosure, the wavelength conversion element converts a portion of a first color beam into a second color beam and outputs the second color beam, and outputs an unabsorbed portion without being subjected to wavelength conversion. That is, light output from the wavelength conversion element includes the first color beam and the second color beam, and mixture of these allows the light, for example, to be white light. By using such a wavelength conversion element, a light source and some optical members are shared, which leads to the reduction in the number of components and the space saving. In this configuration, the focal position of the first color beam set by the first optical system is set to a position shifted from a position on the wavelength conversion element. In general, a focal position of an optical system disposed on the light output side of a wavelength conversion element is set to a position on the wavelength conversion element. Accordingly, in a case where the focal position of first color beam is shifted from the position on the wavelength conversion element, light loss may occur. Meanwhile, the second optical system includes the optical member that concentrates light on a different position depending on a wavelength, thereby making it possible to allow focal positions to coincide with each other for each of the first color beam and the second color beam, and thus to suppress the occurrence of such light loss.

A second light source device in an embodiment of the disclosure includes: a wavelength conversion element that absorbs a portion of an incident first color beam and outputs a second color beam in a wavelength region that is different from a wavelength region of the first color beam, and outputs an unabsorbed portion of the first color beam; and a first optical system that outputs the first color beam toward the wavelength conversion element, while concentrating the first color beam, and sets a focal position of the first color beam to a position shifted from a position on the wavelength conversion element. The wavelength conversion element includes a first element part that absorbs the first color beam and outputs the second color beam; and a second element part that outputs the first color beam, and has a refractive index that is different from a refractive index of the first element part.

A second electronic apparatus of an embodiment of the disclosure includes the second light source device of the foregoing embodiment of the disclosure.

In the second light source device and electronic apparatus of the embodiment of the disclosure, the wavelength conversion element converts a portion of a first color beam into a second color beam and outputs the second color beam, and outputs an unabsorbed portion without being subjected to wavelength conversion. That is, light output from the wavelength conversion element includes the first color beam and the second color beam, and mixture of these allows the light, for example, to be white light. By using such a wavelength conversion element, a light source and some optical members are shared, which leads to the reduction in the number of components and the space saving. In this configuration, the focal position of the first color beam set by the first optical system is set to a position shifted from a position on the wavelength conversion element. In general, a focal position of an optical system disposed on the light output side of a wavelength conversion element is set to a position on the wavelength conversion element. Accordingly, in a case where the focal position of first color beam is shifted from the position on the wavelength conversion element, light loss may occur. Therefore, the wavelength conversion element has the first element part that outputs a second color beam and the second element part that outputs a first color beam, and the second element part has a refractive index that is different from a refractive index of the first element part. By using such a wavelength conversion element, it becomes possible to reduce a difference between respective focal positions of the first color beam and the second color beam, and thus to suppress light loss.

According to the first light source device and electronic apparatus in the embodiment of the disclosure, there is provided the wavelength conversion element that converts a portion of a first color beam into a second color beam and outputs the second color beam, thereby making it possible to share a light source and some optical members, and to achieve the reduction in the number of components and the space saving. Furthermore, the second optical system has the optical member that concentrates light on a different position depending on a wavelength, thus making it possible to suppress the occurrence of light loss. Accordingly, it is possible to suppress the reduction in light use efficiency while achieving the size reduction.

According to the second light source device and electronic apparatus in the embodiment of the disclosure, there is provided the wavelength conversion element that converts a portion of a first color beam into a second color beam and outputs the second color beam, thereby making it possible to share a light source and some optical members, and to achieve the reduction in the number of components and the space saving. Furthermore, the wavelength conversion element has the first element part that outputs a second color beam and the second element part that outputs a first color beam, and the second element part has a refractive index that is different from a refractive index of the first element part. Accordingly, it is possible to reduce a difference between respective focal positions of the first color beam and the second color beam, and thus to suppress light loss. Therefore, it is possible to suppress the reduction in light use efficiency while achieving the size reduction.

It is to be noted that the above description refers to examples of the disclosure. Effects of the disclosure are not limited to the effects described above, and may be any other effects or may further include any other effects.

### BRIEF DESCRIPTION OF DRAWINGS

FIG. 1 is a schematic diagram illustrating a configuration of a light source device according to a first embodiment of the disclosure.

FIG. 2 is a schematic diagram that describes a wavelength conversion element illustrated in FIG. 1 and a focal position of excitation light.

FIG. 3A is a schematic diagram illustrating a configuration of a reflection type wavelength conversion element.

FIG. 3B is a schematic diagram illustrating a configuration of a transmission and reflection type wavelength conversion element.

FIG. 4 is a schematic diagram illustrating a configuration and a working of a main part of a light source device according to a comparative example.

FIG. 5 is a schematic diagram illustrating a configuration and a working of a main part of the light source device illustrated in FIG. 1.

FIG. 6 is a schematic diagram illustrating a configuration of a light source device according to modification example 1.

FIG. 7 is a schematic diagram illustrating an example of focal lengths of a high-dispersion lens and a low-dispersion lens illustrated in FIG. 6.

FIG. 8 is a schematic diagram illustrating a configuration of a light source device according to modification example 2.

FIG. 9 is a schematic diagram illustrating an example of a focal length of a diffractive lens illustrated in FIG. 8.

FIG. 10 is a schematic diagram illustrating a configuration of a light source device according to a second embodiment of the disclosure.

FIG. 11 is a schematic diagram illustrating a planar configuration of a wavelength conversion element illustrated in FIG. 10.

FIG. 12A is a schematic diagram illustrating a working of the wavelength conversion element illustrated in FIG. 10 when a phosphor is disposed on an optical axis.

FIG. 12B is a schematic diagram illustrating a working of the wavelength conversion element illustrated in FIG. 10 when an opening is disposed on the optical axis.

FIG. 13 is a schematic diagram that describes focal positions of excitation light and fluorescence.

FIG. 14A is a schematic diagram that describes a focal position of fluorescence outputted from the phosphor illustrated in FIG. 10.

FIG. 14B is a schematic diagram that describes a focal position of excitation light outputted from the opening illustrated in FIG. 10.

FIG. 15 is a functional block diagram illustrating a configuration of a projection display unit according to an application example.

### MODES FOR CARRYING OUT THE INVENTION

In the following, some embodiments of the disclosure are described in detail with reference to drawings. It is to be noted that description is made in the following order.
1. First Embodiment (An example of a light source device in which a high-dispersion lens is disposed on output side of a wavelength conversion element)
2. Modification Example 1 (An example of a case where a low-dispersion lens is used in combination)
3. Modification Example 2 (An example of a case where a diffractive lens is used)
4. Second Embodiment (An example of a light source device in which a wavelength conversion element has an element part that converts a wavelength and an element part that outputs excitation light)
5. Application Example (An example of a projection display unit).

### [Configuration]

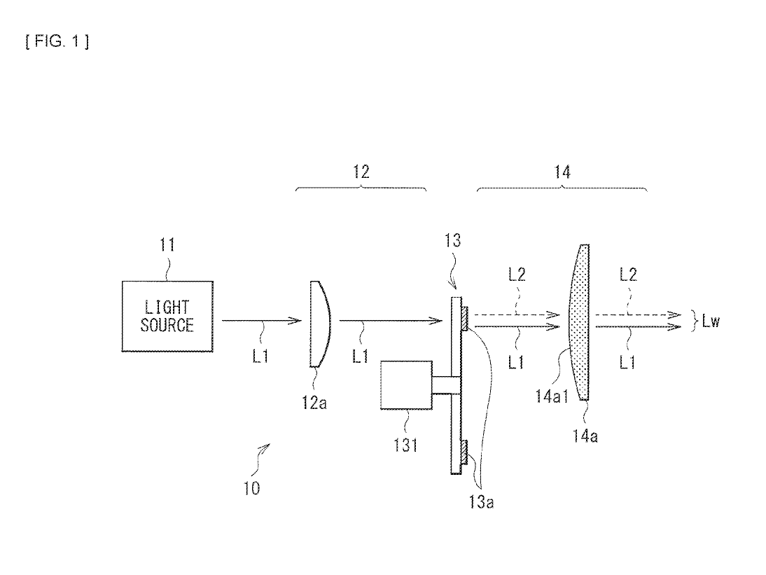

FIG. 1 illustrates a configuration example of a light source device (a light source device 10) according to a first embodiment of the disclosure. The light source device 10 is used, for example, as illumination of an electronic apparatus such as a projection display unit (a projector) described later.

The light source device 10 outputs, for example, white light Lw as illumination light, and includes, for example, a light source 11, a condensing optical system 12, a wavelength conversion element 13, and a collimating optical system 14. The condensing optical system 12 and the collimating optical system 14 are disposed with the wavelength conversion element 13 interposed therebetween. This light source device 10 outputs, for example, the white light Lw as illumination light by color mixture of color light emitted from the light source 11 and fluorescence in the wavelength conversion element 13.

The light source 11 includes, for example, a laser diode (LD), and outputs, for example, blue light L1. The light L1 has an intensity peak in, for example, a blue wavelength region (for example, in a range from 430 nm to 480 nm). This light source 11 also serves as, for example, an excitation light source of the wavelength conversion element 13. It is to be noted that the light L1 of the present embodiment corresponds to a specific example of a “first color beam” of the disclosure. Furthermore, in the following description, the light L1 is assumed to be blue light; however, light in another wavelength region may be used as the light L1 in accordance with the property of a phosphor (a phosphor 13a) to be used in the wavelength conversion element 13. Moreover, the light L1 is not limited to light in a visible region; for example, light in a non-visible region, such as an ultraviolet region, may be used.

The condensing optical system 12 includes, for example, one or a plurality of lenses (one lens 12a is illustrated in this example). The condensing optical system 12 is an optical system that is disposed, for example, between the light source 11 and the wavelength conversion element 13, and concentrates light L1 emitted from the light source 11 toward the wavelength conversion element. It is to be noted that this condensing optical system 12 corresponds to a specific example of a “first optical system” of the disclosure.

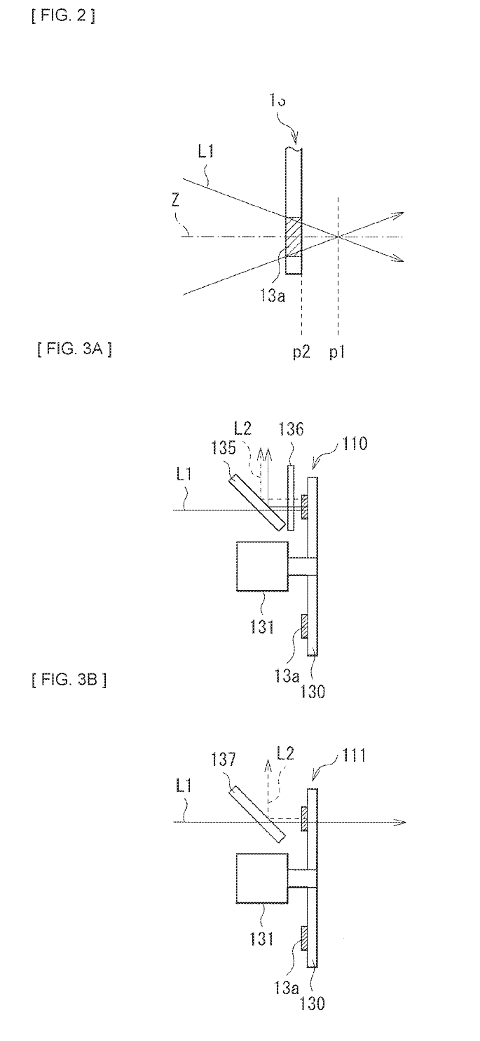

In this condensing optical system 12, as illustrated in FIG. 2, a focal position of the light L1 is set to a position (a position P1 on an optical axis Z) shifted from a position (a position P2 on the optical axis Z) on the wavelength conversion element 13. In other words, the condensing optical system 12 is configured to concentrate the light L1 on the position P1 shifted from the position P2 on the wavelength conversion element 13. One reason for this is that, in a case where the light L1 that is excitation light is concentrated on the wavelength conversion element 13 (specifically, an upper surface of the phosphor 13a), the light density in the phosphor 13a becomes too high, which may result in the reduction in conversion efficiency of the wavelength conversion element 13 as well as the damage on the phosphor 13a. In an example of FIG. 2, the position P1 is set on light output side of the wavelength conversion element 13 (the phosphor 13a). A shift amount of the focal position of this light L1 (a difference between the positions P1 and P2) is set to, for example, a range from 0.5 mm to 1.0 mm.

The wavelength conversion element 13 has a function of absorbing a portion of the light L1 that is incident and outputting light (light L2) in a wavelength region different from the light L1 as well as outputting an unabsorbed portion (a portion not having been subjected to wavelength conversion) of the light L1. It is desirable that this wavelength conversion element 13 have, for example, a so-called transmission type phosphor wheel, because this makes it easy to achieve further size reduction and enhances light use efficiency. The wavelength conversion element 13 of the present embodiment has a configuration of a transmission type. That is, an unabsorbed portion of the light L1 that is excitation light is outputted while being transmitted, and an output direction of this light L1 and an output direction of the light L2 that is fluorescence are the same.

The light L2 is, for example, yellow light, and has an intensity peak in a wavelength region including a green wavelength region and a red wavelength region (for example, in a range from 480 nm to 700 nm). This light L2 may be considered to fluoresce from a surface (a surface including the position P2 illustrated in FIG. 2) of the wavelength conversion element 13 (the phosphor 13a) or may be considered to be emitted from the surface. It is to be noted that the light L2 of the present embodiment corresponds to a specific example of a “second color beam” of the disclosure. Furthermore, in the following description, the light L2 is assumed to be yellow light; however, the light L2 may be light in another wavelength region in accordance with the property of a phosphor to be used in the wavelength region of the light L1 and the wavelength conversion element 13. It is only necessary to select a combination that makes, for example, the white light Lw by color mixture (color synthesis) in accordance with the type of an LD used in the light source 11 and the property of the phosphor 13a of the wavelength conversion element 13.

This wavelength conversion element 13 includes, for example, a substrate 130, the phosphor 13a held on or inside the substrate 130, and a motor 131 (a driver) that drives the substrate 130 to rotate.

The substrate 130 is, for example, a disk-like rotating body (a wheel). The phosphor 13a is formed, for example, along one circumference in a plane (in an annular region) of the substrate 130. This phosphor 13a is configured to allow a portion thereof to be disposed on an optical axis time-divisionally by rotation of the substrate 130. The phosphor 13a includes a material that causes the light L2 to fluoresce with the light L1 as excitation light. As such a phosphor 13a, for example, a powdery, glassy, or crystalline phosphor may be used. It is to be noted that this wavelength conversion element 13 may be provided with an unillustrated cooling mechanism.

It is to be noted that there is described here an example of a configuration in which the wavelength conversion element 13 has a phosphor wheel, i.e., the phosphor 13a formed on the substrate 130 is rotatable; however, depending on excitation energy, etc. of the phosphor 13a, it may be configured not to rotate.

The collimating optical system 14 is an optical system disposed on the light output side of the wavelength conversion element 13. This collimating optical system 14 corresponds to a specific example of a “second optical system” of the disclosure. It is to be noted that, for example, in a case where the light source device 10 is used in, for example, a projection display unit (a projector), the collimating optical system 14 is disposed on the light output side of the wavelength conversion element 13; however, depending on the purpose of use of the light source device 10, another optical system (an optical system that is not the collimating optical system 14) may be disposed.

The collimating optical system 14 is an optical system that collimates incident light into parallel light, and includes, for example, one or a plurality of lenses. In the present embodiment, this collimating optical system 14 includes an optical member that concentrates light on a different position depending on a wavelength (i.e., has a different focal position depending on the wavelength). In the present embodiment, the collimating optical system 14 includes, as an example of such an optical member, a lens (a high-dispersion lens 14a) including a high-dispersion material.

The high-dispersion lens 14a has higher optical dispersion than general optical glass. For example, optical glass such as BSL7 (a trade name, available from OHARA INC.) is used as general glass. However, as the high-dispersion lens 14a, glass having a smaller Abbe number (for example, an Abbe number of 64 or less) than the general optical glass is used. As an example, NPH2 (a trade name, available from OHARA INC.) having an Abbe number of about 20 is used as the high-dispersion lens 14a. This high-dispersion lens 14a corresponds to a specific example of a “first lens” of the disclosure.

The high-dispersion lens 14a has, for example, a convex surface 14a1 on the side of the wavelength conversion element 13. As a wavelength becomes shorter, a focal length of this high-dispersion lens 14a on the side of the wavelength conversion element 13 becomes shorter, whereas as a wavelength becomes longer, the focal length of the high-dispersion lens 14a on the side of the wavelength conversion element 13 becomes longer. Here, the light L1 is blue light, and the light L2 is yellow light (i.e., a wavelength of the light L1 is shorter than a wavelength of the light L2), and therefore the light L2 is able to be concentrated on the position P2, with the light L1 being concentrated on the position P1. Accordingly, in the collimating optical system 14, the light L1 and the light L2 that differ in focal position are able to be collimated by using the high-dispersion lens 14a.

An example of the high-dispersion lens 14a is provided below. As described above, a shift amount of the focal position of the light L1 set by the condensing optical system 12 (a difference between the positions P1 and P2) is set to, for example, a range from 0.5 mm to 1.0 mm. Meanwhile, the light L2 fluoresces from the surface (the surface including the position P2) of the wavelength conversion element 13. In a case where a lens with a focal length of 20 mm is designed by using general optical glass (for example, BSL7 (a trade name, available from OHARA INC.)), a difference between respective focal lengths of blue light (450 nm) and fluorescence (set at a representative value of 550 nm) is about 0.26 mm. It is not possible for such a lens to concentrate blue light and fluorescence, respectively, on the positions P1 and P2 that are different depending on the above-described shift amount. Meanwhile, in a lens designed by using high-dispersion glass (NPH2 (a trade name, available from OHARA INC.)) having an Abbe number of about 20, a difference between respective focal lengths of blue light (450 nm) and fluorescence (set at a representative value of 550 nm) is about 1.0 mm. This makes it possible to concentrate the light L1 and the light L2, respectively, on the positions P1 and P2 that are different depending on the above-described shift amount, or on positions near these positions P1 and P2. For example, in a case where a shift amount of the focal position of the light L1 set by the condensing optical system 12 (a difference between the positions P1 and P2) is set to 1.0 mm, by using glass having an Abbe number of about 20 as the high-dispersion lens 14a, the focal position of the light L1 is able to be set at substantially the same position as the position P1, and the focal position of the light L2 is able to be set in substantially the same position as the position P2.

### [Workings and Effects]

In the light source device 10 of the present embodiment, as illustrated in FIG. 1, when, for example, the blue light L1 is emitted from the light source 11, this light L1 enters the condensing optical system 12. The light L1 is concentrated toward the wavelength conversion element 13 by the condensing optical system 12. In the wavelength conversion element 13, the substrate 130 is driven to rotate, for example, by the motor 131, thereby allowing a portion of the phosphor 13a held by the substrate 130 to be disposed on the optical axis time-divisionally (cyclically). When the light L1 enters this phosphor 13a, a portion of the light L1 is absorbed, and light L2 fluoresces from the wavelength conversion element 13. Meanwhile, the light L1 that has not been absorbed by the phosphor 13a is transmitted through without being subjected to wavelength conversion and outputted from the wavelength conversion element 13 along the same direction as the light L2. In this way, the light L1 that is excitation light and the light L2 that is fluorescence are outputted from the wavelength conversion element 13.

The light L1 and the light L2 outputted from the wavelength conversion element 13 enter the collimating optical system 14, and are collimated into parallel light by the collimating optical system 14. By color mixture of the light L1 and the light L2, the white light Lw as illumination light is outputted.

By using the above-described wavelength conversion element 13, a light source and some optical members are shared, which leads to reduction in the number of components and space saving. Specifically, it is possible to configure the light source 11 that outputs the blue light L1 to serve also as an excitation light source of the wavelength conversion element 13. That is, it is possible to share a light source that outputs the blue light L1 for generating the white light Lw and an excitation light source. Furthermore, this makes it possible to reduce the number of optical members for optical path conversion and optical path splitting.

Furthermore, it is desirable that the transmission type wavelength conversion element 13 be used in the light source device 10. One reason for this is that this makes it easier to achieve the size reduction or have a higher light use efficiency than a reflection type or a transmission and reflection type. As illustrated in FIG. 3A, in a reflection type wavelength conversion element 110, a so-called reflection type wheel is used; the reflection type wheel causes both a portion of incident excitation light (light L1) and light L2 generated from the phosphor 13a to be reflected in the substrate 130 and to be returned to incident side. As illustrated in FIG. 3B, in a transmission and reflection type wavelength conversion element 111, a so-called transmission and reflection type wheel is used; the transmission and reflection type wheel transmits (or reflects) a portion of excitation light (light L1), while reflecting (or transmitting) light L2 generated from the phosphor 13a.

In the reflection type wavelength conversion element 110 (FIG. 3A), however, a dichroic mirror 135 and a phase difference element 136 are disposed on light incident side of the wavelength conversion element 110. In this configuration, turbulence of a polarization plane occurs when the light L1 passes through the phase difference element 136. Accordingly, light loss (loss of the light L1) is likely to occur at the time of optical path splitting in the dichroic mirror 135. Furthermore, in the transmission and reflection type wavelength conversion element 111 (FIG. 3B), a dichroic mirror 137 is disposed on the light incident side of the wavelength conversion element 111. Moreover, respective directions of outputting the light L1 and the light L2 are opposite to each other, and therefore, optical systems (for example, illumination optical systems) after being outputted from the wavelength conversion element 111 are provided separately for the light L1 and the light L2. This leads to increase in size of the device and increase in cost.

By using the transmission type wavelength conversion element 13 as in the present embodiment, the light L1 and the light L2 are outputted in the same direction as described above. Therefore, unlike a case of the above-described transmission and reflection type, there is no need to provide separate optical systems. Furthermore, unlike a case of the reflection type, the phase difference element 136 for spectral diffraction is also unnecessary. For these reasons, a configuration of the transmission type has the highest light use efficiency of the above-described three types, and also it is easy to achieve the size reduction. Therefore, it is desirable that the transmission type wavelength conversion element 13 be used in the light source device 10.

Meanwhile, in the light source device 10, the focal position of the light L1 set by the condensing optical system 12 is set to the position P1 shifted from the position P2 on the wavelength conversion element 13 as illustrated in FIG. 2.

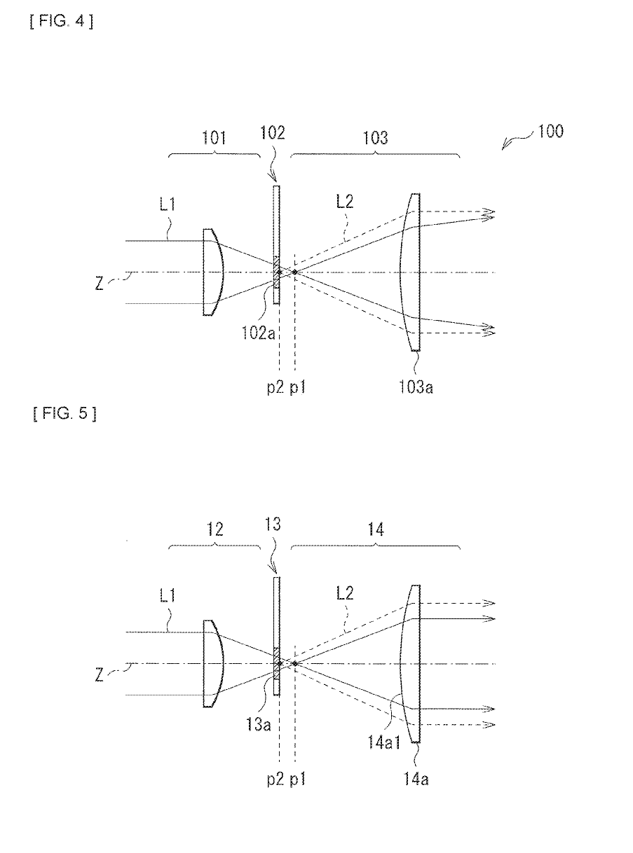

Here, FIG. 4 illustrates a configuration of a main part of a light source device (a light source device 100) of a comparative example. In the light source device 100, a wavelength conversion element 102 and a collimating optical system 103 are disposed on light output side of a condensing optical system 101. A lens 103a including general optical glass (for example, glass having an Abbe number of about 64) is used in the collimating optical system 103. A focal position of the lens 103a is set, for example, at the position P2 to which fluorescence (light L2) is emitted. In this light source device 100, when a focal position of light L1 set by the condensing optical system 101 is shifted from the position P2 to the position P1 for the above-described reasons, it is difficult for the collimating optical system 103 disposed on output side of the wavelength conversion element 102 to adjust respective focal positions of the light L1 and the light L2. In the collimating optical system 103, loss occurs to the light L1 due to a difference between these positions P1 and P2. Furthermore, this loss of the light L1 becomes a factor for the occurrence of irregular color of the white light Lw.

Meanwhile, in the present embodiment, the collimating optical system 14 includes an optical member that concentrates light on a different position depending on the wavelength, specifically, the high-dispersion lens 14a as illustrated in FIGS. 1 and 5. Accordingly, the collimating optical system 14 is able to allow focal positions to coincide with each other (to be corrected) for each of the light L1 and the light L2, thus suppressing the occurrence of light loss, particularly, loss of the light L1 caused by a difference between the positions P1 and P2 as described above. Furthermore, this makes it possible to reduce irregular color of the white light Lw.

As described above, in the present embodiment, there is provided the wavelength conversion element 13 that converts a portion of light L1 into light L2 to output the light L2, thereby making it possible to share a light source and some optical members, and to achieve the reduction in the number of components and the space saving. Furthermore, the collimating optical system 14 disposed on the light output side of the wavelength conversion element 13 includes an optical member (the high-dispersion lens 14a) that concentrates light on a different position depending on the wavelength, thereby making it possible to suppress the occurrence of light loss. Therefore, it is possible to suppress the reduction in light use efficiency while achieving the reduction in size.

Next, modification examples of the foregoing first embodiment and another embodiment are described. In the following, components similar to those in the foregoing first embodiment are assigned with the same reference numeral, and description thereof is omitted where appropriate.

### MODIFICATION EXAMPLE 1

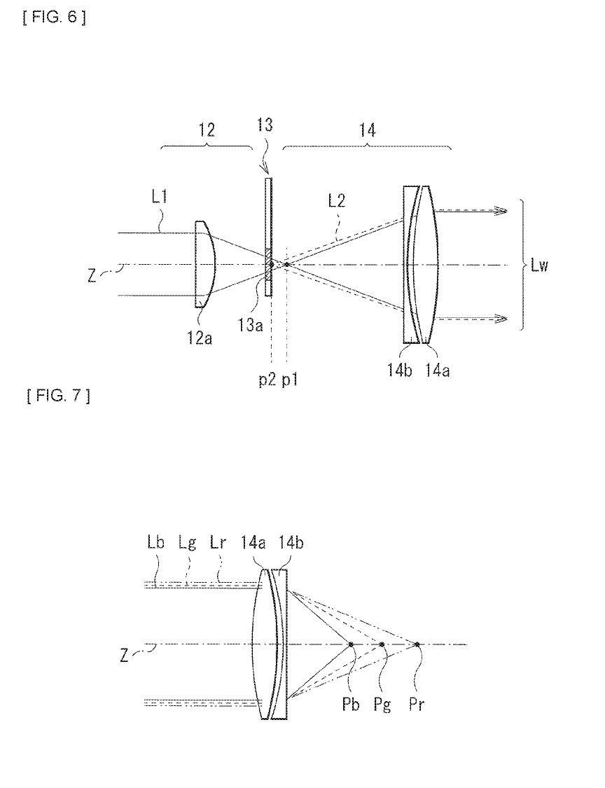

FIG. 6 illustrates a configuration of a main part of a light source device according to modification example 1. In this light source device, as with the foregoing first embodiment, the condensing optical system 12, the wavelength conversion element 13, and the collimating optical system 14 are disposed on the optical axis Z in order from side of the light source 11 (unillustrated in FIG. 6). Furthermore, this light source device outputs, for example, the white light Lw as illumination light by color mixture of color light (light L1) emitted from the light source 11 and fluorescence (light L2) in the wavelength conversion element 13. In the condensing optical system 12, a focal position of the light L1 is set to the position P1 shifted from the position P2 on the wavelength conversion element 13. The collimating optical system 14 includes an optical member that concentrates light on a different position for each wavelength.

However, in this modification example, a lens that is a combination of the high-dispersion lens 14a and a low-dispersion lens 14b (a second lens) including a low-dispersion material is used as an optical member disposed in the collimating optical system 14. FIG. 7 illustrates an example of a focal length of the lens. In this way, the high-dispersion lens 14a is a convex lens, and the low-dispersion lens 14b is a concave lens. By combining the high-dispersion lens 14a with the low-dispersion lens 14b, it becomes possible to set the focal length (a focal length of composition of the high-dispersion lens 14a and the low-dispersion lens 14b) short for a short wavelength and long for a long wavelength, as with the foregoing first embodiment. That is, it is possible to concentrate incident parallel light (light Lb, light Lg, and light Lr) on different positions Pb, Pg, and Pr for different wavelengths. Here, the light L1 is blue light and the light L2 is yellow light (i.e., the wavelength of the light L1 is shorter than the wavelength of the light L2), and therefore the light L2 is able to be concentrated on the position P2, with the light L1 being concentrated on the position P1.

In this way, by using the combination of the high-dispersion lens 14a and the low-dispersion lens 14b, the focal positions are able to coincide with (or be brought close to) the positions P1 and P2 in the collimating optical system 14 also in this modification example, as with the foregoing first embodiment. Furthermore, it is possible to suppress light loss at that time.

Moreover, combination with the high-dispersion lens 14a makes it possible to achieve the following effects. That is, in a case of using the high-dispersion lens 14a alone, a material (an Abbe number) has its limits, and thus there is a limit on adjustable focal positions (the positions P1 and P2). In this respect, the combination with the low-dispersion lens 14b makes it possible to deal with even a large difference between respective focal positions for wavelengths. For example, in a case where a lens is designed to have a focal length of 20 mm by using NPH2 (a trade name, available from OHARA INC.) as the high-dispersion lens 14a (a convex lens) and BSL7 (a trade name, available from OHARA INC.) as the low-dispersion lens 14b (a concave lens), a difference between respective focal positions of the light L1 and the light L2 is 1.7 mm. That is, it is possible to deal with up to 1.7 times a shift amount (a difference between the positions P1 and P2) as compared with the foregoing first embodiment. In other words, it is possible to dispose the wavelength conversion element 13 on side nearer to the light source. As a result, it becomes possible to increase an excitation spot size (substantially equal to an emission spot size), thus making it possible to irradiate the wavelength conversion element 13 with higher-output light L1. It is possible to achieve a bright light source.

### MODIFICATION EXAMPLE 2

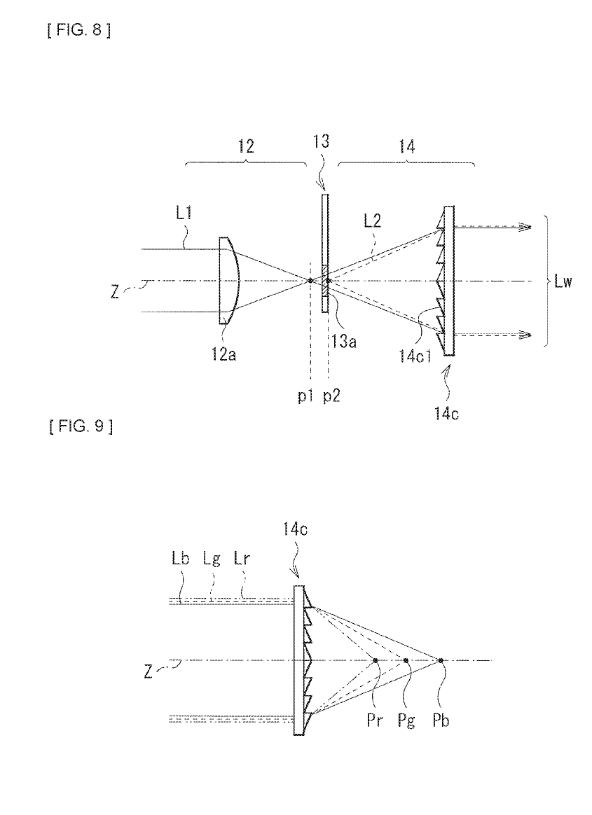

FIG. 8 illustrates a configuration of a main part of a light source device according to modification example 2. In this light source device, as with the foregoing first embodiment, the condensing optical system 12, the wavelength conversion element 13, and the collimating optical system 14 are disposed on the optical axis Z in order from the side of the light source 11 (unillustrated in FIG. 8). Furthermore, this light source device outputs, for example, the white light Lw as illumination light by color mixture of the color light (light L1) emitted from the light source 11 and the fluorescence (light L2) in the wavelength conversion element 13. In the condensing optical system 12, a focal position of the light L1 is set to the position P1 shifted from the position P2 on the wavelength conversion element 13. The collimating optical system 14 includes an optical member that concentrates light on a different position for each wavelength.

However, in this modification example, unlike the foregoing first embodiment, a focal position of the light L1 set by the condensing optical system 12 is set to light incident side of the wavelength conversion element 13. Specifically, the focal position of the light L1 set by the condensing optical system 12 is set to a position shifted to the light incident side from the position P2 on the wavelength conversion element 13. Furthermore, a diffractive lens 14c is used as an optical member disposed in the collimating optical system 14. The diffractive lens 14c has, for example, a surface (a corrugated surface 14c1) including a concave part (a convex part) having a shape of a concentric circle around the optical axis Z on the side of the wavelength conversion element 13. FIG. 9 illustrates an example of a focal length of the diffractive lens 14c. In this way, the diffractive lens 14c concentrates incident parallel light (light Lb, light Lg, and light Lr) on different positions Pb, Pg, and Pr for different wavelengths. In this diffractive lens 14c, the focal length is set long for a short wavelength and set short for a long wavelength, unlike the foregoing first embodiment. That is, here, the light L1 is blue light and the light L2 is yellow light (i.e., the wavelength of the light L1 is shorter than the wavelength of the light L2), and therefore the light L2 is able to be concentrated on the position P2, with the light L1 being concentrated on the position P1.

In this way, by using the diffractive lens 14c as an optical member disposed in the collimating optical system 14, the focal positions are able to coincide with (or be brought close to) the positions P1 and P2 in the collimating optical system 14 also in this modification example, as with the foregoing first embodiment. Furthermore, it is possible to suppress light loss at that time.

Moreover, the diffractive lens 14c is able to achieve an optical property corresponding to an Abbe number of 10 or less. Therefore, by using the diffractive lens 14c, it becomes possible to deal with a larger difference between the focal positions (difference between the positions P1 and P2) than that in the foregoing first embodiment.

### SECOND EMBODIMENT

### [Configuration]

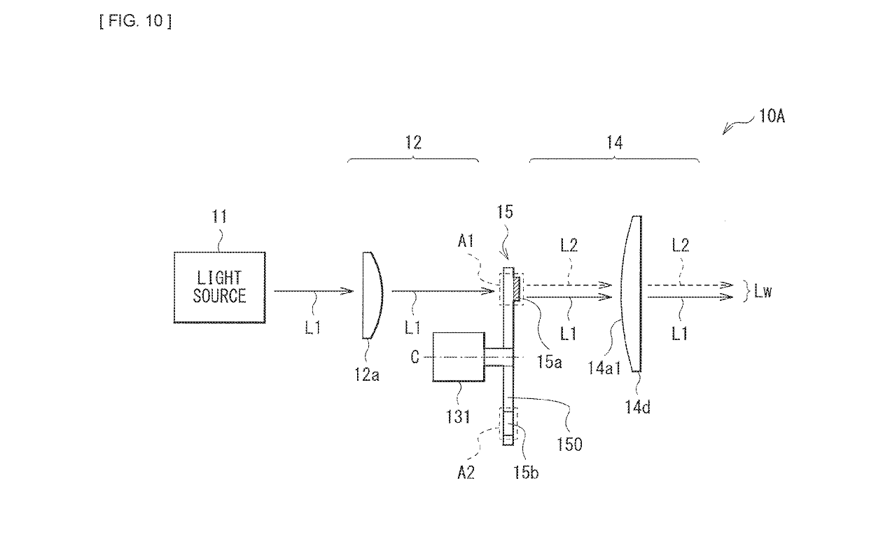

FIG. 10 illustrates a configuration of a light source device (a light source device 10A) according to a second embodiment of the disclosure. In this light source device 10A, as with the foregoing first embodiment, the condensing optical system 12, a wavelength conversion element 15, and the collimating optical system 14 are disposed in order from side of the light source 11. Furthermore, the light source device 10A outputs, for example, the white light Lw as illumination light by color mixture of the color light (light L1) emitted from the light source 11 and the fluorescence (light L2) in the wavelength conversion element 15. Moreover, also in the present embodiment, a focal position of the light L1 set by the condensing optical system 12 is set to a position shifted from a position on the wavelength conversion element 15 (as with the case with the condensing optical system 12 and the wavelength conversion element 13 illustrated in FIG. 2).

As with the wavelength conversion element 13 of the foregoing first embodiment, the wavelength conversion element 15 has a function of absorbing a portion of the light L1 that is incident and outputting light (the light L2) in a wavelength region different from the light L1 and also of outputting an unabsorbed part (a part not having been subjected to wavelength conversion) of the light L1. It is desirable that this wavelength conversion element 15 have, for example, a transmission type phosphor wheel. One reason for this is that this makes it easy to achieve further size reduction and enhances light use efficiency. The wavelength conversion element 15 of the present embodiment has a configuration of a transmission type. That is, the light L1 that is excitation light is outputted while being transmitted through an element part A1, and an output direction of this light L1 and an output direction of the light L2 that is fluorescence are the same.

This wavelength conversion element 15 has the element part A1 (a first element part) that absorbs the light L1 to output the light L2 and an element part A2 (a second element part) that outputs the light L1. The element part A2 has a refractive index different from that of the element part A1.

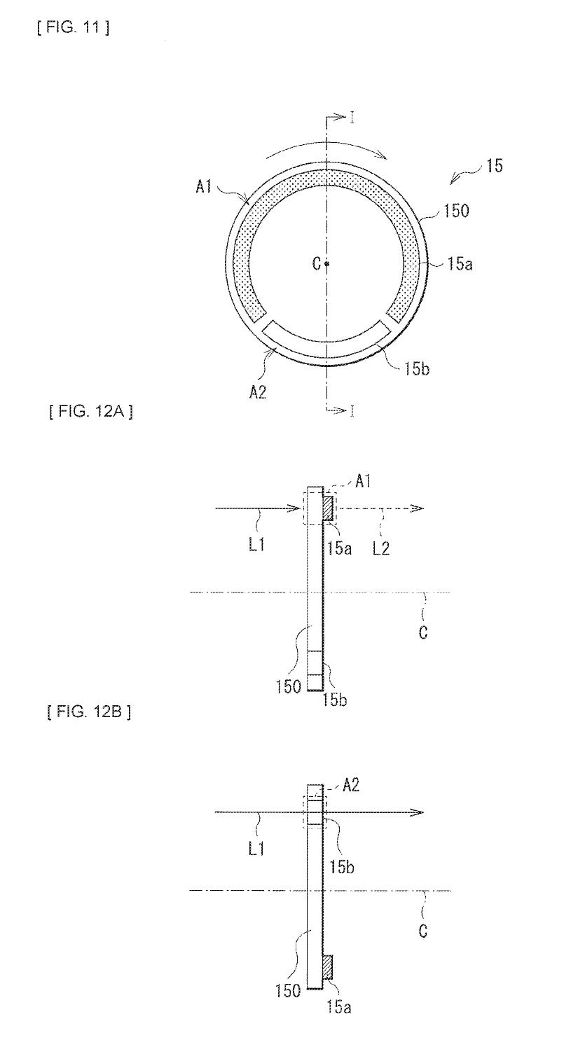

FIG. 11 schematically illustrates a planar configuration of the wavelength conversion element 15. It is to be noted that a cross-sectional configuration taken along a line I-I line in this FIG. 11 corresponds to the configuration of the wavelength conversion element 15 illustrated in FIG. 10. The wavelength conversion element 15 includes, for example, a substrate 150, a phosphor 15a held on or inside the substrate 150, and the motor 131 that drives the substrate 150 to rotate around a shaft C. The substrate 150 is, for example, a disk-like rotating body (a wheel). The phosphor 15a includes a material that causes the light L2 to fluoresce, with the light L1 as excitation light. As such a phosphor 15a, for example, a powdery, glassy, or crystalline phosphor may be used.

These element parts A1 and A2 are each disposed in a selective region in a region (an annular region) on one circumference in a plane of the substrate 150. The ratio of respective regions in which the element parts A1 and A2 are formed may be determined in accordance with white balance of the white light Lw. In the light source device 10A, these element parts A1 and A2 are configured to be disposed on an optical axis time-divisionally and alternately by rotation of the substrate 150. However, these element parts A1 and A2 may be configured not to rotate. It is only necessary to provide a mechanism that is able to switch the element parts A1 and A2 time-divisionally and dispose the switched one of the element parts A1 and A2 on the optical axis.

In the element part A1, for example, the phosphor 15a is formed on the substrate 150, and the light L1 that is incident is subjected to wavelength conversion, and the light L2 is outputted. In the element part A2, for example, the substrate 150 is provided with an opening 15b (with no phosphor 15a being formed). The incident light L1 is transmitted through and is outputted from this element part A2 (without being subjected to wavelength conversion). Inside the opening 15b, air or a material having a refractive index different from the substrate 150 is contained. In the present embodiment, there is an air space inside the opening 15b.

In the present embodiment, the wavelength conversion element 15 has the element part A1 that outputs the light L2 and the element part A2 that transmits and outputs the light L1, and the element parts A1 and A2 differ in the refractive index from each other. It is possible for respective focal positions of the light L1 and the light L2 to coincide with each other (or be brought close to each other; the same applies hereinafter) in accordance with the refractive indexes of the element parts A1 and A2. That is, in the present embodiment, it is possible to correct a focal position of light L1 shifted and set in advance by the condensing optical system 12 to allow the focal position to coincide with a position on the wavelength conversion element 15 when the light L1 passes through the wavelength conversion element 15. In other words, the element part A2 has a compensation material for correcting a focal position gap between the light L1 and the light L2.

A correctable difference (amount of gap) df in the focal position (corresponding to a difference between the positions P1 and P2 in the foregoing first embodiment) is given, for example, by the following expression (1) on the basis of a refractive index n₁ of the element part A1 (a refractive index of the substrate 150), a refractive index n₂ of the element part A2 (a refractive index of the inside the opening 15b), and a thickness t of the substrate 150.

df=t·(1/n₁−1/n₂) (1)

That is, in a case where the focal position of the light L1 set by the condensing optical system 12 is set on light output side of the wavelength conversion element 15, the element part A2 is configured to have a refractive index n₂ that is smaller than the refractive index n₁ of the element part A1. In this case, it is possible to shift the focal position of the light L1 transmitted through the element part A2 in a direction opposite to a traveling direction of a light beam on the optical axis. Meanwhile, in a case where the focal position of the light L1 set by the condensing optical system 12 is set on light incident side of the wavelength conversion element 15, the element part A2 is configured to have the refractive index n₂ that is larger than the refractive index n₁ of the element part A1. In this case, it is possible to shift the focal position of the light L1 transmitted through the element part A2 in the same direction as the traveling direction of a light beam on the optical axis. In this way, by setting the refractive indexes of the element parts A1 and A2 in accordance with the shift amount and the shift direction of the focal position of the light L1 set by the condensing optical system 12, it become possible to bring the focal position of the light L1 close to a position on the wavelength conversion element 15.

An example is provided below. As a material of the substrate 150, sapphire (having a refractive index of about 1.7) is often used because of its optical and mechanical properties. By using a material having a refractive index smaller than the substrate 150 (a material having a refractive index of less than 1.7) in the element part A2, it is possible to shift the focal position of the light L1 in the direction opposite to the traveling direction of a light beam on the optical axis.

Specifically, in a case where a thickness of the substrate 150 is 1.0 mm, and there is an air space inside the opening 15b of the element part A2, the focal position of the light L1 is shifted by 0.4 (=(1/1.0)−(1/1.7)) mm in the direction opposite to the traveling direction of a light beam. Alternatively, in a case where a thickness of the substrate 150 is 1.0 mm, and the opening 15b of the element part A2 is filled with a material having a thickness of 1.0 mm and a refractive index of about 1.5, the focal position of the light L1 is shifted by 0.08 (=(1/1.5)−(1/1.7)) mm in the direction opposite to the traveling direction of a light beam. Likewise, by using a material having a refractive index larger than the substrate 150 (a material having a refractive index of more than 1.7) in the element part A2, it is possible to shift the focal position of the light L1 in the same direction as the traveling direction of a light beam on the optical axis.

The collimating optical system 14 is an optical system that is disposed on the light output side of the wavelength conversion element 15 and collimates incident light into parallel light. This collimating optical system 14 includes, for example, one or a plurality of lenses (a lens 14d is illustrated in this example). It is to be noted that, for example, in a case where the light source device 10A is used in, for example, a projection display unit (a projector), the collimating optical system 14 is disposed on the light output side of the wavelength conversion element 15; however, depending on the purpose of use of the light source device 10A, another optical system (an optical system that is not the collimating optical system 14) may be disposed.

### [Workings and Effects]

In the light source device 10A of the present embodiment, as illustrated in FIG. 10, when, for example, the blue light L1 is emitted from the light source 11, this light L1 enters the condensing optical system 12. The light L1 is concentrated toward the wavelength conversion element 15 by the condensing optical system 12. In the wavelength conversion element 15, the substrate 150 is driven to rotate, for example, by the motor 131. Accordingly, the element part A1 (the phosphor 15a held by the substrate 150) and the element part A2 (the opening 15b) of the wavelength conversion element 15 are alternately disposed on the optical axis time-divisionally.

At this time, in a case where the element part A1 is disposed on the optical axis as illustrated in FIG. 12A, the light L1 incident on the wavelength conversion element 15 is absorbed by the phosphor 15a. Accordingly, the wavelength conversion element 15 causes the light L2 to fluoresce to output the light L2. Meanwhile, in a case where the element part A2 is disposed on the optical axis as illustrated in FIG. 12B, the light L1 incident on the wavelength conversion element 15 is transmitted through the opening 15b and is outputted from the wavelength conversion element 15. In this way, the light L1 that is excitation light and the light L2 that is fluorescence are time-divisionally and alternately outputted along the same direction from the wavelength conversion element 15.

The light L1 and the light L2 having been outputted from the wavelength conversion element 15 enter the collimating optical system 14, and are collimated into parallel light by the collimating optical system 14. By color mixture of the light L1 and the light L2, the white light Lw as illumination light is outputted.

By using the above-described wavelength conversion element 15, it becomes possible to achieve the reduction in the number of components and the space saving, for reasons similar to those in the foregoing first embodiment. Furthermore, the transmission type wavelength conversion element 15 is used in the light source device 10A, which makes it easier to achieve the size reduction or makes it possible to enhance light use efficiency more than a reflection type or a transmission and reflection type.

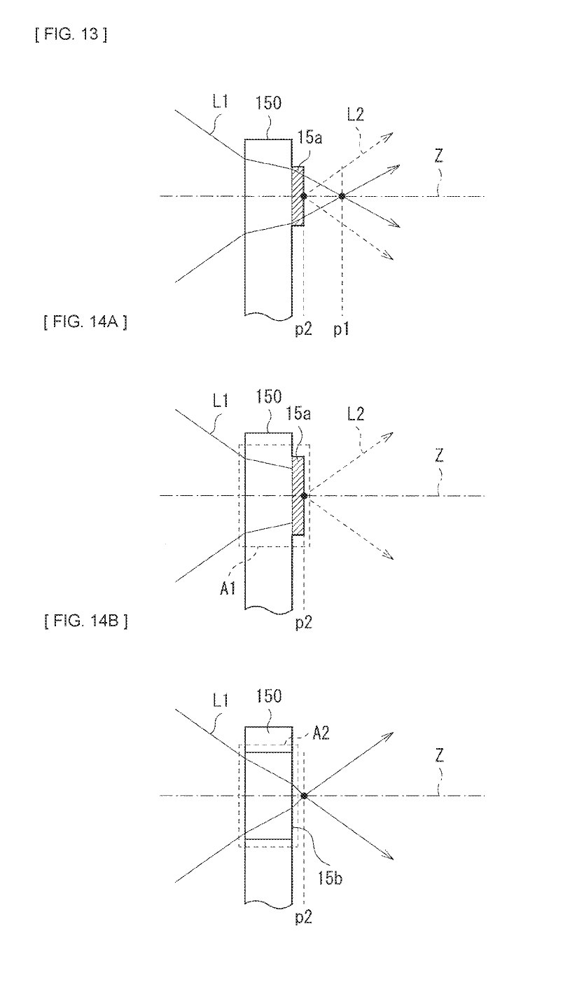

Moreover, also in the present embodiment, a focal position of the light L1 set by the condensing optical system 12 is set to a position shifted from a position on the wavelength conversion element 15. In this case, as illustrated in FIG. 13, light loss may occur due to a difference between the focal position of the light L1 (the position P1) and the position P2 on the wavelength conversion element 15. In general, a focal position of an optical system (the collimating optical system 14 in this example) disposed on the light output side of the wavelength conversion element 15 is set at the position P2 on the wavelength conversion element 15. Therefore, loss of the light L1 occurs due to the above-described difference between the focal positions (the difference between the positions P1 and P2).

Accordingly, in the present embodiment, the element part A1 that converts a wavelength of the light L1 to output the light L2 and the element part A2 that transmits and outputs the light L1 are provided in separate regions in the wavelength conversion element 15; the element part A2 has a refractive index different from the element part A1. Here, a focal position of the light L2 outputted from the element part A1 and a focal position of the light L1 outputted from the element part A2 are illustrated in FIGS. 14A and 14B, respectively. In this way, the element part A2 has the refractive index that is different from the refractive index of the element part A1, thereby enabling the focal position of the light L1 to coincide with the focal position of the light L2 (the position P2). Therefore, it is possible to suppress light loss (loss of the light L1).

As described above, in the present embodiment, there is provided the wavelength conversion element 15 that converts a portion of the light L1 into the light L2 to output the light L2, thereby making it possible to share a light source and some optical members, and to achieve the reduction in the number of components and the space saving. Furthermore, the wavelength conversion element 15 includes the element part A1 that outputs the light L2 and the element part A2 that outputs the light L1, and the element part A2 has a refractive index different from the element part A1. Accordingly, it is possible to reduce the difference between the respective focal positions of the light L1 and the light L2 and thus to suppress the light loss. Therefore, it is possible to suppress the reduction in light use efficiency while achieving the size reduction.

Next, a projector (a projection display unit) is described as an example of an electronic apparatus to which the light source device in any of the foregoing embodiments, etc. is applied. In the following, illustration and description are provided, referring to the light source device 10 of the foregoing first embodiment; however, any of the light source devices in the foregoing modification examples 1 and 2 and the foregoing second embodiment may be applied as well. Furthermore, any of the light source devices of the foregoing embodiments, etc. may be applied to, for example, various types of light source devices that emit white light, such as a vehicle head lamp (head light), besides the projection display unit described below.

### APPLICATION EXAMPLE

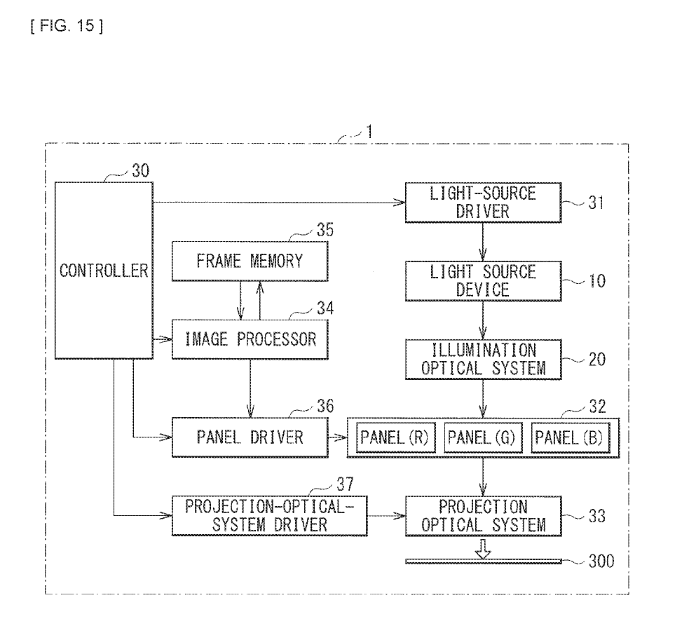

FIG. 15 is a functional block diagram illustrating an overall configuration of the projection display unit (a projection display unit 1) according to an application example. This projection display unit 1 is a display unit that projects an image onto, for example, a screen 300 (a projection surface). Although not illustrated, the projection display unit 1 is coupled to, for example, a computer, such as a PC, and external image supply devices, such as various image players, through an interface (I/F), and performs projection onto the screen 300 on the basis of an image signal to be inputted to this interface.

The projection display unit 1 includes, for example, a light-source driver 31, the light source device 10, an illumination optical system 20, a light modulation device 32, a projection optical system 33, an image processor 34, a frame memory 35, a panel driver 36, a projection-optical-system driver 37, and a controller 30.

The light-source driver 31 outputs a pulse signal for controlling emission timing of the light source 11 disposed in the light source device 10. This light-source driver 31 includes, for example, a PWM setting section, a PWM-signal generating section, a limiter, etc. that are unillustrated. On the basis of control of the controller 30, the light-source driver 31 controls a light source driver of the light source device 10 and performs, for example, PWM control on the light source 11, thereby turning the light source 11 on and off or performing brightness adjustment.

Although not illustrated in particular, the light source device 10 includes, for example, the light source driver that drives the light source 11 and a current-value setting section that sets a current value when the light source 11 is driven, besides the components described in the foregoing first embodiment. The light source driver generates a pulse current having a current value set by the current-value setting section in synchronization with a pulse signal to be inputted from the light-source driver 31 on the basis of power supplied from an unillustrated power supply circuit. The generated pulse current is supplied to the light source 11.

The illumination optical system 20 is an optical system that illuminates each panel of the light modulation device 32, for example, on the basis of light (the white light Lw) emitted from the light source device 10, and includes, for example, a beam forming element, an illuminance equalization element, a polarization separation element, a color separation element, etc.

The light modulation device 32 generates image light by modulating light (illumination light) outputted from the illumination optical system 20 on the basis of an image signal. The light modulation device 32 includes, for example, three transmission or reflection type light valves corresponding to respective colors of R, G, and B. Examples of the light valves include a liquid crystal panel that modulates blue light (B), a liquid crystal panel that modulates red light (R), and a liquid crystal panel that modulates green light (G). As a reflection type liquid crystal panel, for example, a liquid crystal element such as liquid crystal on silicon (LCOS) may be used. However, the light modulation device 32 is not limited to a liquid crystal element; for example, other light modulation elements, such as a digital micromirror device (DMD), may be used. Respective color beams of R, G, and B modulated by the light modulation device 32 are synthesized by an unillustrated cross dichroic prism, etc., and are led to the projection optical system 33.

The projection optical system 33 includes a lens group, etc. for projecting the light modulated by the light modulation device 32 onto the screen 300 to form an image on the screen 300.

The image processor 34 acquires an image signal inputted from the outside, and performs determination of an image size, determination of a resolution, determination of whether an image is a still image or a moving image, etc. In a case of a moving image, the image processor 34 also determines attributes, etc., such as a frame rate, of image data. Furthermore, in a case where the resolution of the acquired image signal is different from a display resolution of each liquid crystal panel of the light modulation device 32, the image processor 34 performs a resolution conversion process. The image processor 34 expands each processed image in the frame memory 35 with respect to each frame, and outputs, as a display signal, the image of each frame expanded in the frame memory 35 to the panel driver 36.

The panel driver 36 drives each liquid crystal panel of the light modulation device 32. The driving of this panel driver 36 changes transmittance of the light in each pixel disposed in each liquid crystal panel, thereby forming an image.

The projection-optical-system driver 37 includes a motor that drives a lens disposed in the projection optical system 33. This projection-optical-system driver 37 drives, for example, the projection optical system 33 in accordance with control of the controller 30, and performs, for example, zoom adjustment, focus adjustment, diaphragm adjustment, etc.

The controller 30 controls the light-source driver 31, the image processor 34, the panel driver 36, and the projection-optical-system driver 37.

This projection display unit 1 includes the above-described light source device 10, thus making it possible to achieve bright display while reducing the entire size of the device.

Although the description has been made by referring to the embodiments and the modification examples as mentioned above, the disclosure is not limited to the foregoing embodiments, etc. and may be modified in a variety of ways. For example, the components of the optical system (for example, the light source, the condensing optical system, the wavelength conversion element, the collimating optical system, etc.) described in the foregoing embodiments, etc. are merely examples; the optical system does not have to include all the components, and may further include other components. It is to be noted that the effects described in this specification are merely examples and are nost limited to those described above, and there may be other effects.

Furthermore, the disclosure may have the following configurations.

(1) A light source device including:
a wavelength conversion element that absorbs a portion of an incident first color beam and outputs a second color beam in a wavelength region that is different from a wavelength region of the first color beam, the wavelength conversion element outputting an unabsorbed portion of the first color beam;
a first optical system that outputs the first color beam toward the wavelength conversion element, while concentrating the first color beam, the first optical system setting a focal position of the first color beam to a position shifted from a position on the wavelength conversion element; and
a second optical system that is disposed on light output side of the wavelength conversion element, and includes an optical member that concentrates light on a different position depending on a wavelength.

(2) The light source device according to (1), in which the second optical system includes, as the optical member, a first lens including a high-dispersion material.

(3) The light source device according to (2), in which the first lens has a convex surface on side of the wavelength conversion element.

(4) The light source device according to (2) or (3), in which
the second optical system further includes a second lens including a low-dispersion material,
the first lens is a convex lens, and
the second lens is a concave lens.

(5) The light source device according to any one of (2) to (4), in which
the first optical system and the second optical system are disposed on an optical axis with the wavelength conversion element being interposed between the first optical system and the second optical system, and
the focal position of the first color beam set by the first optical system is set on the light output side of the wavelength conversion element.

(6) The light source device according to (1), in which the second optical system includes a diffractive lens as the optical member.

(7) The light source device according to (6), in which the diffractive lens has a corrugated surface on side of the wavelength conversion element.

(8) The light source device according to (6) or (7), in which
the first optical system and the second optical system are disposed on an optical axis with the wavelength conversion element being interposed between the first optical system and the second optical system, and
the focal position of the first color beam set by the first optical system is set on light incident side of the wavelength conversion element.

(9) The light source device according to any one of (1) to (8), in which the wavelength conversion element outputs, while transmitting, the first color beam and the second color beam along same direction. (10) The light source device according to any one of (1) to (9), in which the second optical system is a collimating optical system. (11) The light source device according to any one of (1) to (10), in which the wavelength conversion element includes
a phosphor held on or inside a substrate, and
a driver that drives the substrate to rotate.

(12) A light source device including:
a wavelength conversion element that absorbs a portion of an incident first color beam and outputs a second color beam in a wavelength region that is different from a wavelength region of the first color beam, the wavelength conversion element outputting an unabsorbed portion of the first color beam; and
a first optical system that outputs the first color beam toward the wavelength conversion element, while concentrating the first color beam, the first optical system setting a focal position of the first color beam to a position shifted from a position on the wavelength conversion element,
the wavelength conversion element including
   a first element part that absorbs the first color beam and outputs the second color beam, and
   a second element part that outputs the first color beam, and has a refractive index that is different from a refractive index of the first element part.

(13) The light source device according to (12), in which
the wavelength conversion element includes a substrate including the first element part and the second element part,
in the first element part, a phosphor is held on or inside the substrate, and
in the second element part, the substrate is provided with an opening.

(14) The light source device according to (13), in which the second element part contains, inside the opening, air or a material having a refractive index that is different from a refractive index of the substrate.

(15) The light source device according to any one of (12) to (14), in which
the focal position of the first color beam set by the first optical system is set on light output side of the wavelength conversion element, and
the second element part has the refractive index that is smaller than the refractive index of the first element part.

(16) The light source device according to any one of (12) to (14), in which
the focal position of the first color beam set by the first optical system is set on light incident side of the wavelength conversion element, and
the second element part has the refractive index that is larger than the refractive index of the first element part.

(17) The light source device according to any one of (12) to (16), in which the first element part and the second element part are configured to be disposed on same optical path time-divisionally.

(18) The light source device according to (17), in which
the wavelength conversion element includes
   the substrate having the first element part and the second element part, and
   a driver that drives the substrate to rotate, and
the first element part and the second element part are each disposed in a selective region on one circumference in a plane of the substrate.

(19) An electronic apparatus including a light source device,
the light source device including
a wavelength conversion element that absorbs a portion of an incident first color beam and outputs a second color beam in a wavelength region that is different from a wavelength region of the first color beam, the wavelength conversion element outputting an unabsorbed portion of the first color beam,
a first optical system that outputs the first color beam toward the wavelength conversion element, while concentrating the first color beam, the first optical system setting a focal position of the first color beam to a position shifted from a position on the wavelength conversion element, and
a second optical system that is disposed on light output side of the wavelength conversion element, and includes an optical member that concentrates light on a different position depending on a wavelength.

(20) An electronic apparatus including a light source device,
the light source device including
a wavelength conversion element that absorbs a portion of an incident first color beam and outputs a second color beam in a wavelength region that is different from a wavelength region of the first color beam, the wavelength conversion element outputting an unabsorbed portion of the first color beam, and
a first optical system that outputs the first color beam toward the wavelength conversion element, while concentrating the first color beam, the first optical system setting a focal position of the first color beam to a position shifted from a position on the wavelength conversion element,
the wavelength conversion element including
   a first element part that absorbs the first color beam and outputs the second color beam, and
   a second element part that outputs the first color beam, and has a refractive index that is different from a refractive index of the first element part.

This application claims the benefit of Japanese Priority Patent Application JP2016-43606 filed with the Japan Patent Office on Mar. 7, 2016, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A light source device comprising:
a wavelength conversion element that absorbs a portion of an incident first color beam and outputs a second color beam in a wavelength region that is different from a wavelength region of the first color beam, the wavelength conversion element outputting an unabsorbed portion of the first color beam;
a first optical system that outputs the first color beam toward the wavelength conversion element, while concentrating the first color beam, the first optical system setting a focal position of the first color beam to a position shifted from a position on the wavelength conversion element; and
a second optical system that is disposed on light output side of the wavelength conversion element, and includes an optical member that concentrates light on a different position depending on a wavelength.

2. The light source device according to claim 1, wherein the second optical system includes, as the optical member, a first lens including a high-dispersion material.

3. The light source device according to claim 2, wherein the first lens has a convex surface on side of the wavelength conversion element.

4. The light source device according to claim 2, wherein
the second optical system further includes a second lens including a low-dispersion material,
the first lens comprises a convex lens, and
the second lens comprises a concave lens.

5. The light source device according to claim 2, wherein
the first optical system and the second optical system are disposed on an optical axis with the wavelength conversion element being interposed between the first optical system and the second optical system, and
the focal position of the first color beam set by the first optical system is set on the light output side of the wavelength conversion element.

6. The light source device according to claim 1, wherein the second optical system includes a diffractive lens as the optical member.

7. The light source device according to claim 6, wherein the diffractive lens has a corrugated surface on side of the wavelength conversion element.

8. The light source device according to claim 6, wherein
the first optical system and the second optical system are disposed on an optical axis with the wavelength conversion element being interposed between the first optical system and the second optical system, and
the focal position of the first color beam set by the first optical system is set on light incident side of the wavelength conversion element.

9. The light source device according to claim 1, wherein the wavelength conversion element outputs, while transmitting, the first color beam and the second color beam along same direction.

10. The light source device according to claim 1, wherein the second optical system comprises a collimating optical system.

11. The light source device according to claim 1, wherein the wavelength conversion element includes
a phosphor held on or inside a substrate, and
a driver that drives the substrate to rotate.

12. A light source device comprising:
a wavelength conversion element that absorbs a portion of an incident first color beam and outputs a second color beam in a wavelength region that is different from a wavelength region of the first color beam, the wavelength conversion element outputting an unabsorbed portion of the first color beam; and
a first optical system that outputs the first color beam toward the wavelength conversion element, while concentrating the first color beam, the first optical system setting a focal position of the first color beam to a position shifted from a position on the wavelength conversion element,
the wavelength conversion element including
a first element part that absorbs the first color beam and outputs the second color beam, and
a second element part that outputs the first color beam, and has a refractive index that is different from a refractive index of the first element part.

13. The light source device according to claim 12, wherein
the wavelength conversion element includes a substrate including the first element part and the second element part,
in the first element part, a phosphor is held on or inside the substrate, and
in the second element part, the substrate is provided with an opening.

14. The light source device according to claim 13, wherein the second element part contains, inside the opening, air or a material having a refractive index that is different from a refractive index of the substrate.

15. The light source device according to claim 12, wherein
the focal position of the first color beam set by the first optical system is set on light output side of the wavelength conversion element, and
the second element part has the refractive index that is smaller than the refractive index of the first element part.

16. The light source device according to claim 12, wherein
the focal position of the first color beam set by the first optical system is set on light incident side of the wavelength conversion element, and
the second element part has the refractive index that is larger than the refractive index of the first element part.

17. The light source device according to claim 12, wherein the first element part and the second element part are configured to be disposed on same optical path time-divisionally.

18. The light source device according to claim 17, wherein
the wavelength conversion element includes
a substrate having the first element part and the second element part, and
a driver that drives the substrate to rotate, and
the first element part and the second element part are each disposed in a selective region on one circumference in a plane of the substrate.

19. An electronic apparatus comprising a light source device,
the light source device including
a wavelength conversion element that absorbs a portion of an incident first color beam and outputs a second color beam in a wavelength region that is different from a wavelength region of the first color beam, the wavelength conversion element outputting an unabsorbed portion of the first color beam,
a first optical system that outputs the first color beam toward the wavelength conversion element, while concentrating the first color beam, the first optical system setting a focal position of the first color beam to a position shifted from a position on the wavelength conversion element, and
a second optical system that is disposed on light output side of the wavelength conversion element, and includes an optical member that concentrates light on a different position depending on a wavelength.

20. An electronic apparatus comprising a light source device,
the light source device including
a wavelength conversion element that absorbs a portion of an incident first color beam and outputs a second color beam in a wavelength region that is different from a wavelength region of the first color beam, the wavelength conversion element outputting an unabsorbed portion of the first color beam, and
a first optical system that outputs the first color beam toward the wavelength conversion element, while concentrating the first color beam, the first optical system setting a focal position of the first color beam to a position shifted from a position on the wavelength conversion element,
the wavelength conversion element including
a first element part that absorbs the first color beam and outputs the second color beam, and
a second element part that outputs the first color beam, and has a refractive index that is different from a refractive index of the first element part.
